(19) United States
(12) Patent Application Publication
(10) Pub. No.: US 2004/0031445 A1
(43) Pub. Date: Feb. 19, 2004

(54) Animal transport hand truck

(76) Inventor: Shelton E. Harrison JR., West Hollywood, CA (US)

Correspondence Address: Shelton E. Harrison, Jr., 6643 Poplar Pike, Memphis, TN, 38119, US

(21) Appl. No.: 10/219,115

(22) Filed: Aug. 15, 2002

(51) Int. Cl. B60P 3/04

(52) U.S. Cl. 119/400

(57) ABSTRACT

Disclosed is an animal transportation hand truck for travelers. The device features wheels on one end so that it can be rolled when tilted. The container in which the animal is to be carried depends from a support mechanism so that, being pulled in one direction by gravity, the container remains level when the rest of the device is tilted. Portions of the device can be removed or collapsed for greater mobility and convenience. A luggage compartment, retractable cover, a mount for pre-existing pet containers, shock absorbers, heater/air-conditioning unit, and other enhancements to the device are also disclosed. The device can be used to transport items other than pets that a user wishes to keep level during transportation.

### CROSS-REFERENCE TO RELATED APPLICATIONS

None.

### STATEMENT REGARDING FEDERALLY SPONSORED RESEARCH AND DEVELOPMENT

None.

### REFERENCE TO SEQUENCE LISTING, A TABLE, OR A COMPUTER PROGRAM LISTING APPENDIX

None.

### BACKGROUND OF THE INVENTION

1. Field of the Invention

The present invention relates to wheeled luggage, hand trucks, and animal transportation devices.

2. Description of Related Art

Luggage with wheels, hand trucks, and wheeled pet-carrying devices are known. Wheeled luggage that includes two wheels on one corner so that the unit can be rolled only when tilted is known; see, e.g., U.S. Pat. No. 3,842,953 to Royet. Collapsible frames for use in rolling luggage, such as that disclosed in U.S. Pat. No. 3,861,695 to Shourek et al, are known.

Suitcases with four wheels are not often used by modern travelers because such “boxes-on-wheels” fall over easily when rolled across an uneven surface. In recent years, the international popularity of the two-wheeled luggage approach has exploded. This approach is superior to the four-wheeled approach from the traveler's perspective because (1) the two-wheeled unit rests more stably when not being rolled, since weight is distributed evenly between the wheels and the side of the luggage that does not have wheels, and (2) when the two-wheeled unit is tilted so as to be rollable, the user's own hand stabilizes the unit while he or she is pulling the unit so that it is less likely to fall over.

Four-wheeled pet carriers, such as U.S. Pat. No. 5,701,843 to Lazides and U.S. Pat. No. 6,095,090 to Burns et al., have not gained market acceptance for the same reasons why four-wheeled luggage is unpopular: they fall over too easily, frustrating the user and terrorizing the pet. Most pet owners, therefore, simply carry their pets in cages by hand, which approach becomes tiresome quickly. What is needed is a two-wheeled pet carrying device for travelers, preferably one which can also serve as luggage to carry the user's personal items.

### BRIEF SUMMARY OF THE INVENTION

The present invention provides travelers a wheeled pet transportation device that is easier to use than prior devices. A pet chamber is suspended on a hand truck frame so that the pet chamber remains level even though the orientation of the frame relative to the ground changes once the user tilts the unit in order to roll it. The same approach can be used to transport any object which a user wishes to keep level.

Additional features of the invention are disclosed. Portions of the frame can be collapsed, retracted, or removed for convenient stowage. A suitcase can be attached to the frame for added convenience, and the pet chamber can include any number of comforts, such as a battery-operated fan or radio. The pet chamber and the support mechanism by which the pet chamber is attached to the frame can be removed. A kickstand can be provided to enhance the stability of the unit when not in motion. The unit can also be attached to the human body for hands-free towing.

### BRIEF DESCRIPTION OF THE DRAWINGS

FIG. 1 presents a side view of the invention resting on the ground.

FIG. 2 presents a side view of the invention once the handle has been lifted so that the unit rests on its wheels.

FIG. 3 presents a top view of the invention.

FIG. 4 presents a top view of the invention after the pet chamber has been removed and the frame partially collapsed.

FIG. 5 presents a side view of a particular embodiment of the invention suitable for transporting three animals.

FIG. 6 presents a side view of an embodiment of the invention wherein the pet chamber is positioned on the handle side of the suitcase.

FIG. 7 presents a side view of the embodiment in FIG. 6 after the pet chamber has been removed and the pet chamber suspension mechanism collapsed.

FIG. 8 presents a side view of the embodiment depicted in FIG. 6 after the frame has been partially collapsed.

FIG. 9 presents a side view of an embodiment of the invention wherein only one suspension post rather than two suspension posts is used.

FIG. 10 presents an embodiment of the invention suitable for carrying a pre-existing piece of pet luggage.

FIG. 11 presents a perspective view of the frame which carries the pet chamber and suitcase.

FIG. 12 presents a side view of an embodiment of the invention wherein the pet chamber can be enclosed by a cover.

FIG. 13 presents a side view of the embodiment depicted in FIG. 12 after the cover has been closed.

FIG. 14 presents a perspective view of a trunk which can be used in place of the suitcase depicted in other figures.

FIG. 15 depicts a perspective view of the trunk depicted in FIG. 14 after it has been opened and expanded.

FIG. 16 depicts a side view of an embodiment of the invention that includes a kickstand to increase the stability of the unit when it is at rest.

FIG. 17 depicts a side view of an embodiment of the invention that includes a spring-loaded stabilizer mechanism.

FIG. 18 depicts an exploded view of elements of the basic suspension mechanism whereby the pet chamber is supported.

FIG. 19A depicts a side view of a clip can be used to attach the pet chamber to the suspension mechanism.

FIG. 19B depicts a side view of the clip depicted in FIG. 19A after the clip has been bent inward to create a space.

FIG. 19C depicts a perspective view of the clip attached to a support bar.

FIG. 20 depicts a perspective view of a removable suspension post.

FIG. 21 depicts a top view of an embodiment of the invention which includes a deployable handle that can be attached to a user's belt for hands-free towing of the unit. FIG. 22 depicts a side view of an embodiment of the invention which includes a ski for use in snow or sand.

### DETAILED DESCRIPTION OF THE INVENTION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all rights whatsoever.

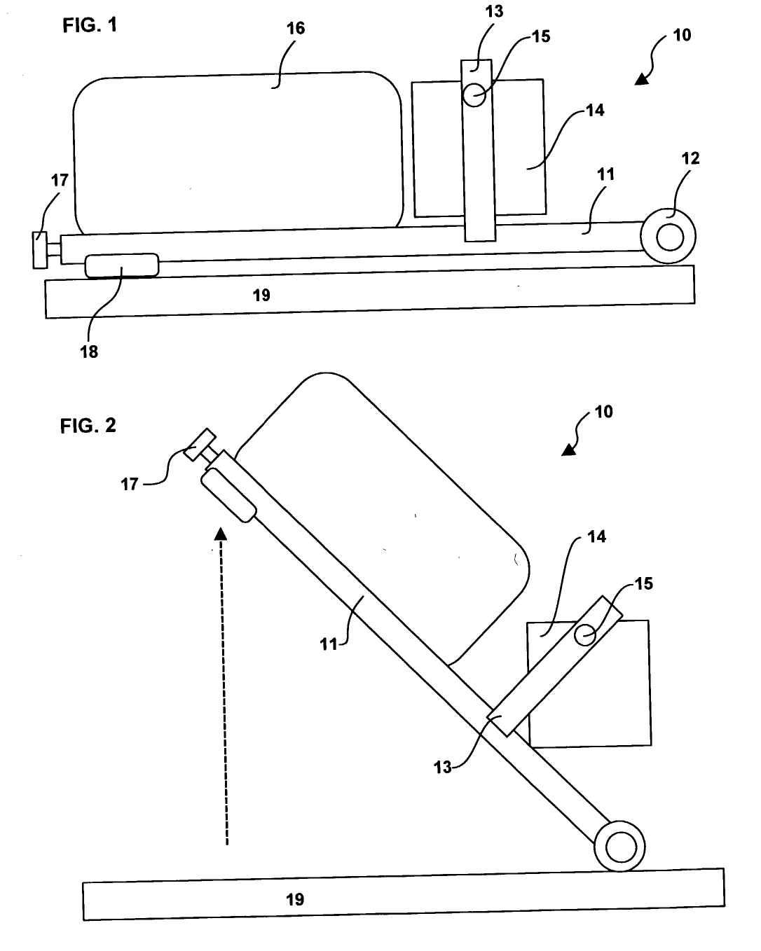

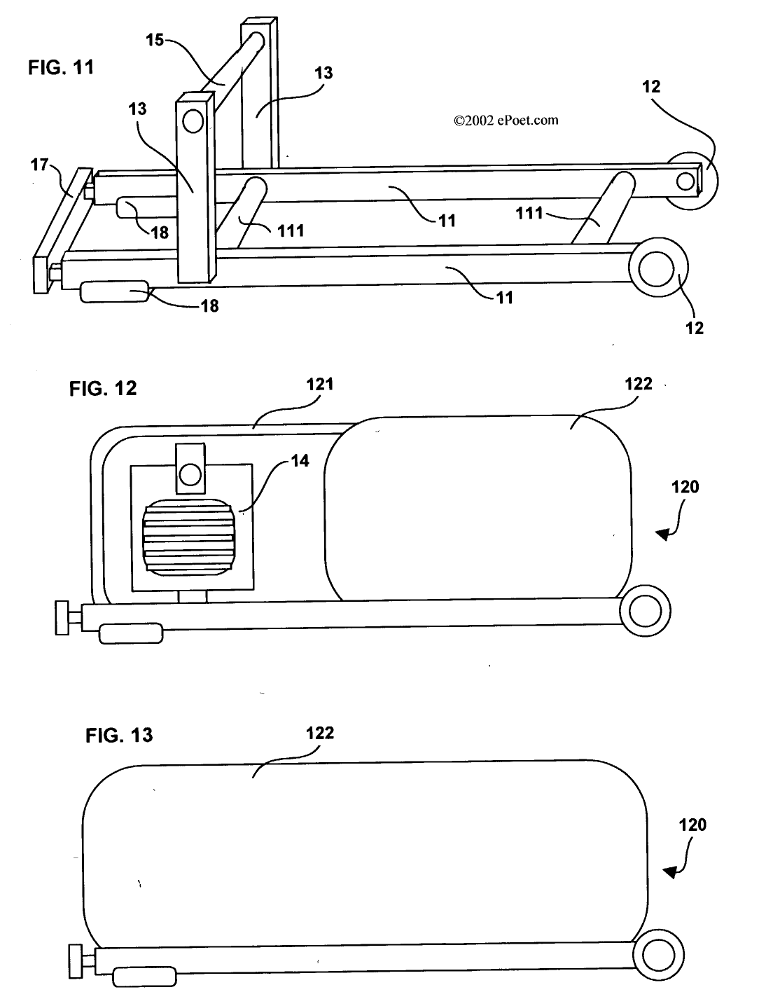

Disclosed in FIG. 1 is a side view of a device 10 that includes a frame 11 with a wheel 12 attached to one end; a second wheel, not visible in FIG. 1, is attached to the frame behind the depicted wheel (see FIG. 11 for view of the second wheel). Mounted upon the frame 11 is a suspension post 13; a second suspension post, not visible in FIG. 1, is attached to the frame behind the depicted suspension post (see FIG. 11 for view of the second suspension post).

Referring to FIG. 1, the suspension posts 13 support a round support bar 15 from which is suspended a pet chamber 14 that is movably attached to the support bar 15. The pet chamber 14 hangs from and can revolve around the bar 15. The frame also bears an attached suitcase 16, a handle 17 for pulling the frame, and a small pedestal 18 which supports the frame 11 when it is resting upon a surface 19 such as the ground.

FIG. 2 depicts a side view of the same unit 10 after it has been moved into position by the user (not shown) so as to be rollable. When a user wishes to move the frame 11, she grabs the handle 17 and lifts the frame 11 up in the direction of the depicted motion arrow so that the frame can be rolled on its wheels 12. Since the pet chamber 14 is suspended so as to be able to revolve around the bar 15 and gravity pulls the pet chamber 14 toward the ground 19, the pet chamber 14 remains level when the unit is in the depicted position, even though the frame 11 in FIG. 2 is now oriented at an angle relative to the ground 19 that is different from the angle depicted in FIG. 1.

Thus, the flat floor of the pet chamber 14 remains basically parallel to the earth's horizon, allowing a pet inside the pet chamber to feel as though it stands or lies upon level ground.

The pet chamber's retention of the same basic spatial orientation relative to the horizon, i.e., the flat floor of the pet chamber lying in a plane which is perpendicular to the line described by the earth's center of gravity and the pet chamber's center of gravity, is made possible by the fact that the center of gravity of the pet chamber lies below the bar from which it is suspended. The earth's gravitational pull causes the center of gravity of the pet chamber to move toward the earth's center of gravity as far as it can. Revolving motion is allowed by the movable nature of the pet chamber's attachment to the support bar. But, of course, this attachment does not allow the distance between the pet chamber and the support bar to increase; the pet chamber can only revolve around the axis described by the round support bar, the flat floor of the pet chamber never exceeding a certain radial distance from the support bar.

Thus, since the unit is constructed so that the lowest point the pet chamber's center of gravity can reach corresponds to the position in which the floor of the pet chamber is level with the horizon, the pet chamber constantly moves to whatever position results in a level floor.

The unit as a whole is essentially a hand truck similar to those commonly used to move heavy objects, except that this hand truck is specially equipped with a self-leveling surface. As such, the present invention can be used not only to transport animals but to transport any number of other objects that a user would prefer to keep level. For instance, the depicted “pet chamber” can carry more than pets—bottles, food, delicate electronics, or other objects that should not be turned on their sides.

The suspension posts can be hinged to the frame so that they can fold down as depicted in FIGS. 6, 7, and 8. Alternately, the suspension posts can be welded or otherwise permanently and immovably fixed to the frame. Alternately, the suspension posts can be removably clamped to the frame so that a single suspension post can be used with multiple frames; a removable suspension post is depicted in FIG. 20. The entire suspension mechanism and pet chamber can also be manufactured separately and sold as an accessory that can be used with and attached to pre-existing hand trucks. In this way, people who already own a handtruck can gain the benefits of the present invention by simply adding an accessory onto their existing hand truck.

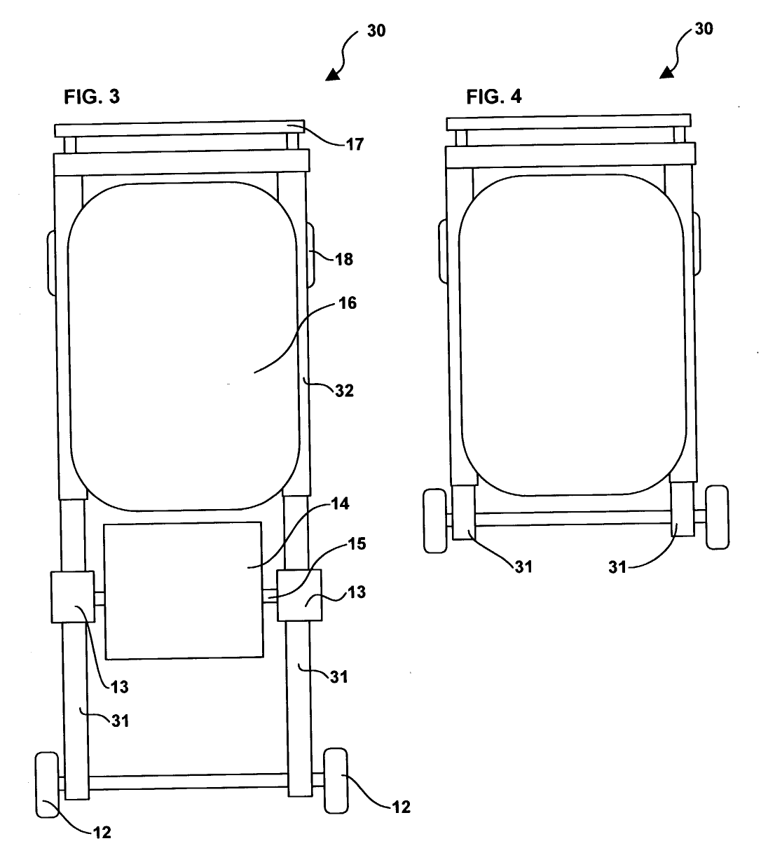

FIG. 3 presents a top view of an embodiment 30 of the invention. From this angle, both wheels 12 and both suspension posts 13 can be viewed, and the bar 15 from which the pet chamber 14 is suspended can be seen better. In this embodiment, the frame 32 can be collapsed by retraction of the telescoping member 31 that holds the wheels 12. First, the suspension posts 13 and pet chamber 14 must be removed. FIG. 4 shows the unit 30 after it has been collapsed. In the collapsed state, the unit 30 is appropriate for carrying on a plane, as is the separated pet chamber 14.

The pet chamber may include several features. Windows with bars or Plexiglas and ventilation holes can be included so that the pet occupant can see out of the chamber and have access to fresh air without the pet being allowed to escape from the chamber. Padding of the chamber will make it more comfortable. A battery-operated radio or other sound producing machine can be included in the pet chamber to calm the pet; similarly, an electronic fan, heater, air conditioner, air purifier, or flat-panel display can also be included in the pet chamber to comfort or distract the pet. The floor of the pet chamber can be mounted on springs so as to make the ride smoother. Shock absorbers can alternately be included in the suspension posts or in the frame.

The suitcase can be constructed as conventional suitcases, in materials ranging from canvas to leather or other material. The suitcase can be glued or riveted to the frame or attached to the frame with Velcro, snaps or zippers so that it is easily removable and can be constructed so as to fold out into a hanging back. The pet chamber can be covered in the same material used for the suitcase but should have a sturdy internal frame for the protection of the pet occupant. The frame, suspension posts, and support bar can be made of metal, plastic, wood, or other material strong enough to support the suitcase and pet chamber. The suspension posts can be covered with durable twine so that they can double as scratching posts. The wheels can be solid or inflatable.

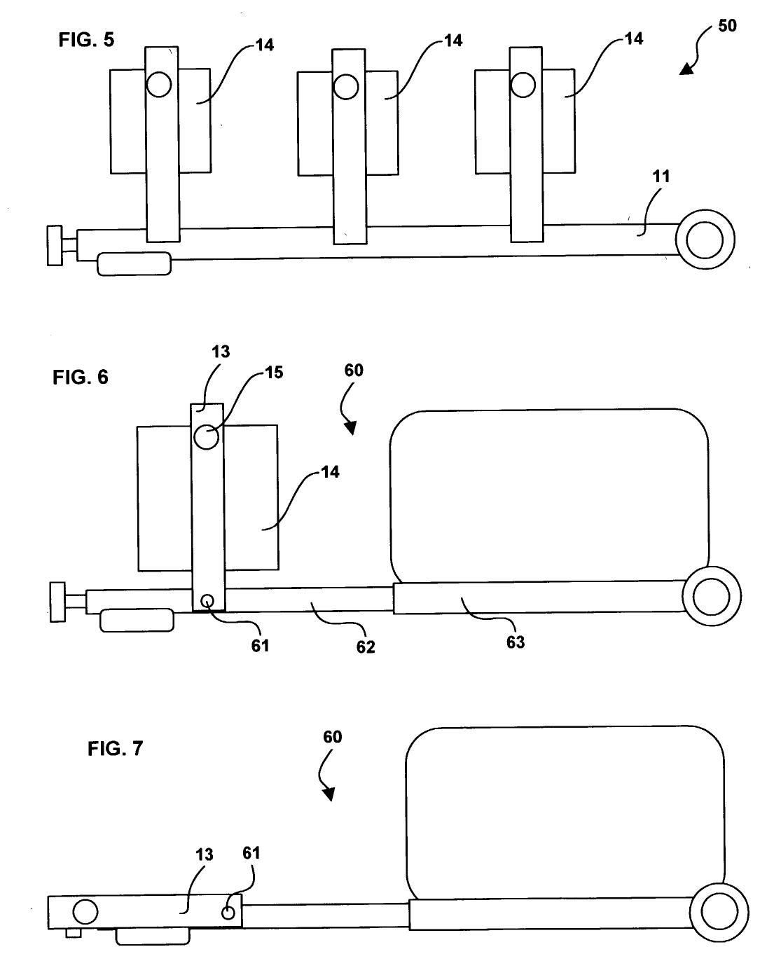

FIG. 5 depicts an embodiment 50 of the invention that dispenses with the suitcase in favor of providing two additional pet chambers 14. Each chamber 14 is independently suspended so as to remain level when the frame 11 is tilted.

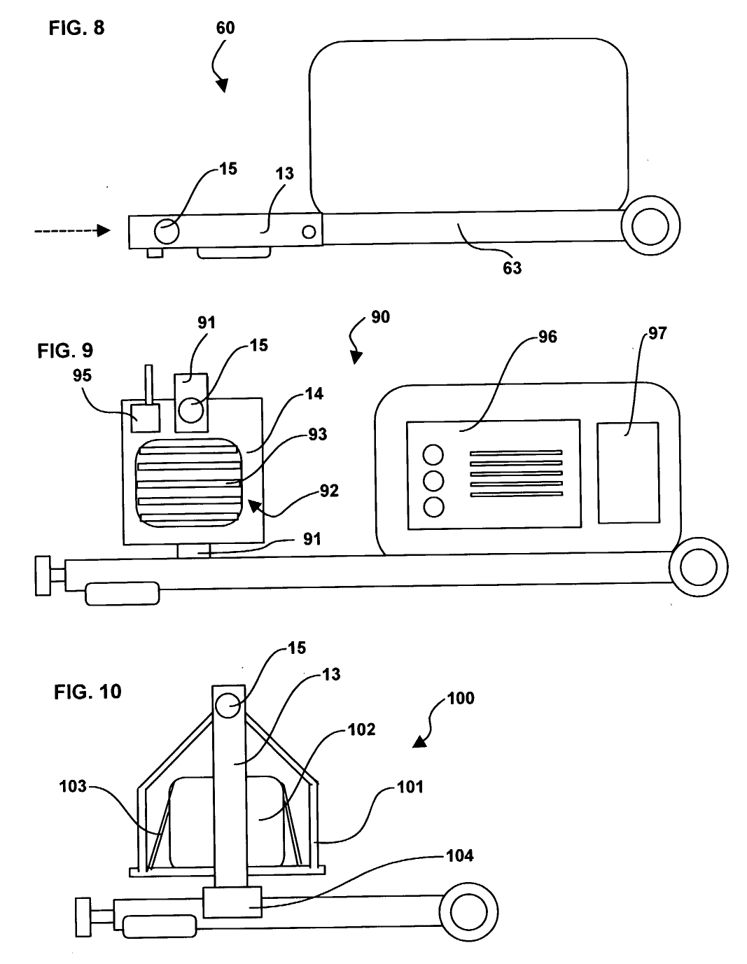

FIG. 6 depicts an embodiment 60 of the invention wherein the pet chamber 14 is mounted toward the handle end of the frame, which is constructed to be collapsible by function of telescoping action, whereby the handle side portion 62 of the frame retracts into the wheel side portion of the frame 63. When the pet chamber 14 is removed, the suspension posts 13, which are hinged 61 to the frame, can fold down as depicted in FIG. 7. Once the suspension posts 13 are thereby collapsed, the frame can also partially collapse as depicted in FIG. 8. This collapsing of the frame is similar to the approach commonly used in conventional wheeled luggage and collapsible hand trucks.

FIG. 9 depicts an embodiment 90 of the invention wherein, instead of a suspension post appearing on either side of the pet chamber, only one suspension post 91 appears. This suspension post 91 reaches over the pet chamber 14 to hold the support bar 15 from either end, thereby serving as a cantilever support for the support bar 15 and the pet chamber 14 it supports. This embodiment allows a window 92 or door to appear on the side of the pet chamber 14 without being partially obscured by a second suspension post as in other embodiments. In FIG. 9, a window 92 with bars 93 to keep the pet inside the pet chamber 14 appears. A battery-operated radio 95 can be attached to the pet chamber 14. Instead of a suitcase, a heater/air-conditioner/fan 96 and a flat-panel display 97 can be mounted on the unit 90 for the comfort or distraction of the pet once travel is finished.

FIG. 10 presents another embodiment 100, which does not include a suitcase. This unit includes a rigid housing 101 that includes a flat bottom held by rigid bars that are movably attached to the support bar 15. This housing 101 is open on the sides so that a pre-existing pet carrier 102 can be set upon the housing 101 and strapped to it with straps 103. In this way, users who already own luggage for carrying pets can still use such pre-existing luggage while enjoying the benefits of the present invention. The housing 101 can be made of metal, plastic or other rigid material. The suspension posts 13 are mounted on shock absorbers 104. The essential features of the frame 11 and most of the structural elements mounted upon it appear in FIG. 11, a perspective view. Notice that the pet chamber and the suitcase are not included in this illustration so that the frame, the support bar 15, and other elements can be seen better. From this angle, we can see two crossbars 111 perpendicular to and connecting the two sides of the frame 11 to stabilize the unit as a whole.

FIG. 12 depicts another embodiment 120, which includes rails 121 upon which a covering 122 is movably and removably mounted. This cover can be fabric, such as cotton or canvas, or some other material, such as plastic or vinyl. This cover 122 slides along the rails 121 so that it can enclose the pet chamber 14 as depicted in FIG. 13. This ability to enclose the pet chamber makes it possible for the unit to be used to transport animals in harsh environments, such as rain or extreme cold. It also allows creation of a relatively closed environment so that an air-conditioner, heater or air purifier, as depicted in FIG. 9, can be used to create and maintain a more favorable environment underneath the cover for the comfort and safety of the pet being transported. The cover 122 can include air ventilation holes and can include a clear plastic window.

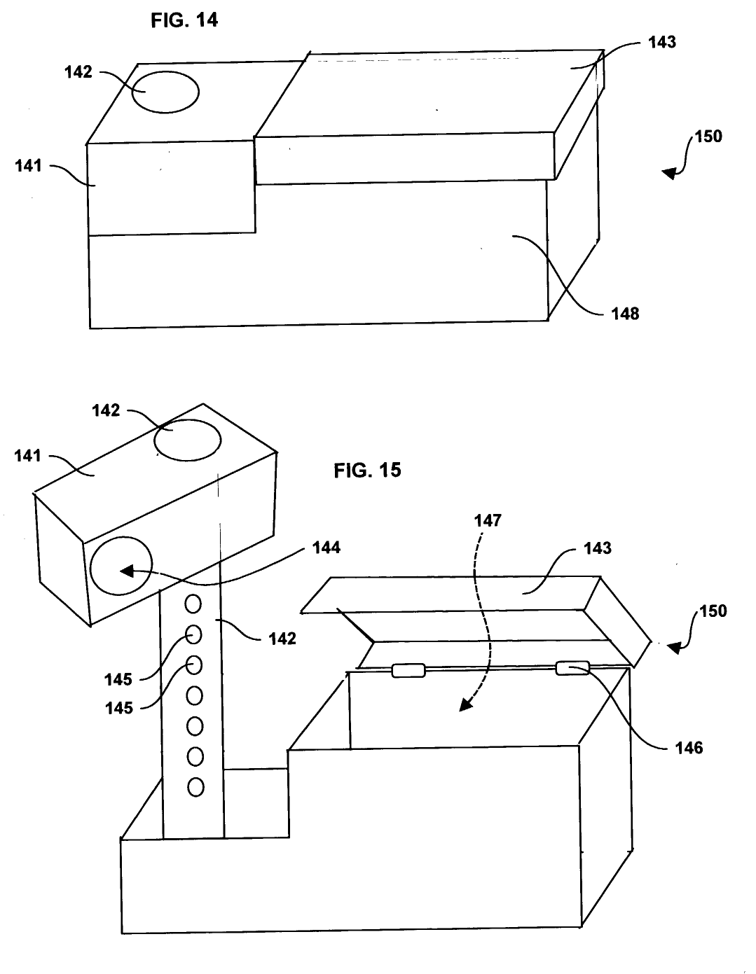

FIG. 14 depicts a trunk 150 that can be mounted on the frame of a given embodiment instead of a suitcase. This trunk 150 includes a box-like container 148 with a lid 143 which covers part of the box 148. Also included is a pet playhouse 141 movably attached to a telescoping, collapsible post 142. When the trunk 150 is resting on a flat surface, the lid 143 can be opened on its hinges 146 to create a space 147, for pet toys or bedding, as depicted in FIG. 15. Meanwhile, the collapsible post 142 can be expanded so that the pet playhouse 141 is held above the rest of the unit 150. This playhouse 141 contains an opening 144 for pets. The post 142 also contains peg holes 145 so that additional pet playhouses or other entertainment accessories can be attached to the post 142.

In this way, a “cat tree” or “cat furniture,” which usually includes several different levels and chambers of carpet-lined floors and walls, can be made collapsible and easily portable. For instance, when such a trunk 150 is used in conjunction with the remainder of the invention, a user can easily transport her cat, and then, upon arrival to her destination, open the trunk 150 to create a space for the cat to live in and entertain itself. The pet entertainment center can also include a retractable clothesline for suspending cat toys and other features.

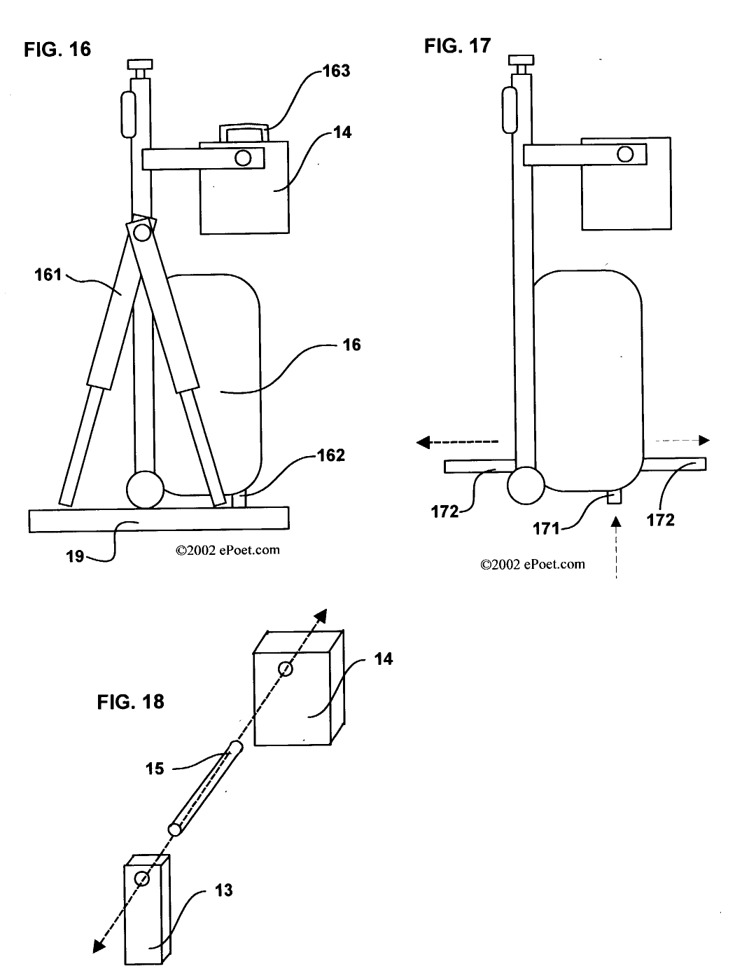

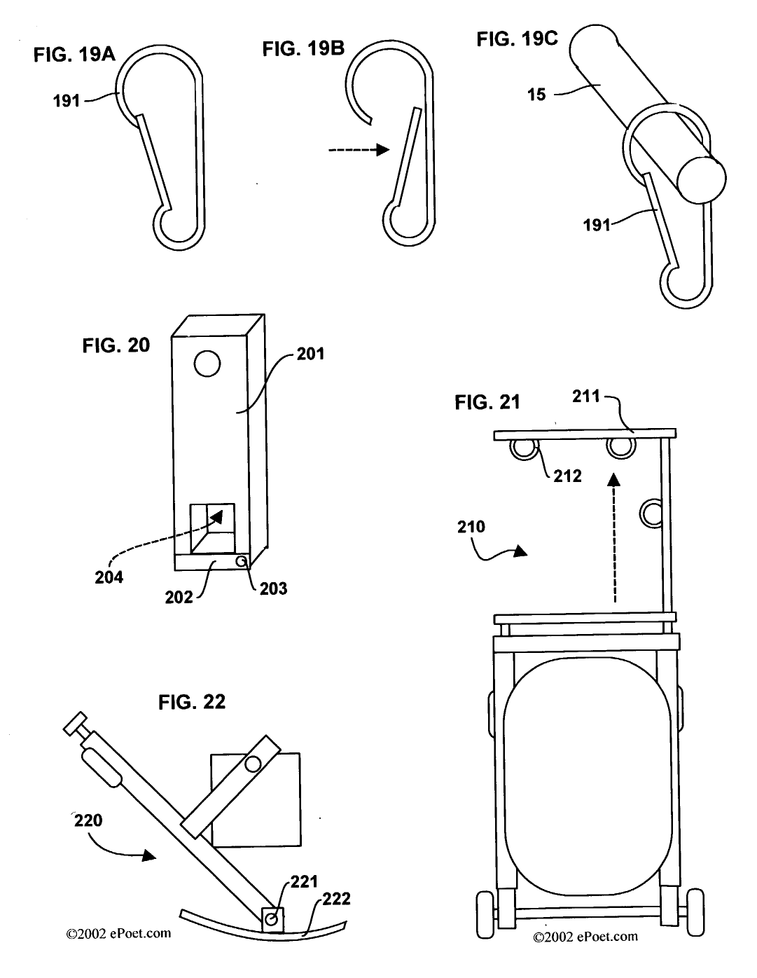

FIG. 16 depicts an embodiment of the invention which includes telescoping kickstands 161 and a pedestal 162 attached to the bottom of the suitcase 16. These additional features can be used to provide additional stability to the unit when it is standing upright as shown. A hanging loop 163 is mounted on top of the pet chamber 14 for use with the clip depicted in FIG. 19A as an alternative way of attaching the pet chamber to the support bar.

FIG. 17 depicts an embodiment of the invention which includes a pedestal 171 and two spring-loaded stabilizer bars 172. When pressure is exerted on the pedestal 171, as in the case of standing the unit upright and letting it rest on the wheels and the pedestal, the pedestal 171 serves as a button to release the spring-loaded stabilizer bars 172. Once they are released, the bars 172 must be manually collapsed back into the unit.

FIG. 18 depicts an exploded view of some of the basic elements of the suspension mechanism: a suspension post 13, the support bar 15, and the pet chamber 14, which fit together along the depicted arrow line. The round support bar 15 passes through the round holes of the pet chamber 14 so that the pet chamber 14 can revolve around the bar 15. The bar 15 an be coated with Teflon to reduce friction between the bar 15 and the pet chamber 14.

FIG. 19A depicts a side view of a clip used to attach the pet chamber to the support bar. The pet chamber is attached to the bottom of the clip 191, which is made of metal or plastic or another flexible material so that it can bend as depicted in FIG. 19B to create a space. The support bar is inserted through this space, and then the clip 191 returns to its original shape, as shown in FIG. 19C.

FIG. 20 depicts a perspective view of a removable suspension post 201, which features a bottom cover 202 which is attached to the remainder of the unit by hinge 203. This cover 202 partly encloses a space 204 into which a frame can be inserted so that the unit can be attached to a hand truck frame.

FIG. 21 depicts a top view of an embodiment 210 of the invention which includes a deployable/retractable handle 211. This extension contains a number of rings 212 that can be attached to a user's belt for hands-free towing of the unit. A clip such as that depicted in FIG. 19A can be used to clip a user's belt loop to one of the depicted rings, or the users belt can be fed directly through one of the rings. This retractable handle with belt-attachment mechanism can be manufactured and sold separately so as to be used with pre-existing luggage and hand trucks.

FIG. 22 depicts a side view of an embodiment 220 of the invention in which a ski 222 is attached to the frame by hinge 221, the ski taking the place of wheels so that the invention can be used in snow and sand.

It should also be noted that the invention can be used to transport a human baby instead of a pet. In such application, the pet chamber is replaced with a baby seat or crib.

Licensing information can be obtained through www.epoet.com.

What is claimed is:

1. A device comprising:
a holder suitable for holding objects;
a rigid frame;
a support member, to which member the holder is movably attached and from which member the holder depends, by function of the earth's gravitational pull;
a rolling mechanism comprising at least one wheel attached to the frame and positioned to bear some of the weight of the frame when the device rests upon a flat surface;
a non-rolling portion of the frame, said portion of the frame being positioned to bear some of the weight of the frame when the device rests upon a flat surface.

2. The device in claim 1 additionally comprising a handle with which a user can lift or pull the frame; or
a belt-attachment mechanism.

3. The device in claim 1 wherein a portion of the frame is retractable or collapsible.

4. The device in claim 1 wherein the support member can be retracted, folded, or removed from the frame or from the holder.

5. The device in claim 1 additionally comprising at least one window, at least one air vent, an electronic device, a heater, a fan, an air-conditioner, a trunk containing collapsible pet furniture, an attachment mechanism suitable for attaching to a pre-existing container, a shock absorber, a kickstand, a spring-loaded stabilizer device, or a movable cover suitable for at least partially enveloping the holder.

6. The device in claim 1 additionally comprising a second support member, a piece of luggage suitable for use in transporting a traveler's personal items, or a second holder.

7. The device in claim 1 wherein a portion of the frame, the support member or the holder is made of metal, plastic or wood.

8. The device in claim 1 wherein the rolling mechanism is positioned on the frame in such a way that when a user lifts one end of the frame, the weight of the frame is borne by the user and the rolling mechanism.

9. The device in claim 1 additionally comprising a flat surface of the holder configured so as to rest parallel to the horizon when the holder is depending from the support member.

10. The device in claim 1 additionally comprising a first flat surface of the holder configured so as to rest parallel to a second flat surface both when both the rolling mechanism and the non-rolling portion of the frame rest upon the second flat surface and also when only the rolling mechanism rests upon the second flat surface.

11. A means of transporting a container by way of hand truck so that when the hand truck is tilted, the container does not tilt.

12. The means in claim 11 additionally comprising means of removably attaching a container to a hand truck, means of affecting the temperature of a container, means of stabilizing a hand truck, means of hands-free towing of a hand truck, means of folding or collapsing a hand truck, means of keeping an animal in a container, or means of attaching a hand truck to a human body.

13. A hand truck comprising a surface which is movably coupled to the frame of the hand truck so that gravity keeps the surface level when the frame is tilted.

14. The device in claim 13 additionally comprising at least one wheel, at least one ski, at least one window, at least one air vent, at least one bar, an electronic device, a heater, a fan, an air-conditioner, a trunk containing collapsible pet furniture, an attachment mechanism suitable for attaching to a pre-existing animal container, a kickstand, a spring-loaded stabilizer device, a movable cover, a piece of luggage suitable for use in transporting a traveler's personal items, a shock absorber, a second flat surface, a handle, a belt-attachment mechanism, or a towing mechanism.
